(19) United States
(12) Patent Application Publication
(10) Pub. No.: US 2006/0017962 A1
(43) Pub. Date: Jan. 26, 2006

(54) Systems and methods of printer customization using radio frequency devices

(76) Inventors: Chris Anthony Burdette, Richmond, KY (US); Steven E. Ritter, Nicholasville, KY (US); Mark Stephen Underwood, Lexington, KY (US); Terry Lee Wells, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/897,242

(22) Filed: Jul. 22, 2004

(51) Int. Cl. G06F 15/00

(52) U.S. Cl. 358/1.15

(57) ABSTRACT

A printer configuration system (10) with a radio frequency device (12) with memory (18) for storing a plurality of printer device custom parameter data and a signal pathway (22) for communicating with the radio frequency device (12). The system further comprises a host (20) capable of accessing the radio frequency device (12) through the signal pathway (22) for obtaining the printer device parameter data stored in the radio frequency device (12) which is read by the host (20) via the signal pathway (22) and used by a printer (30) associated with the host (20) to configure printer related functions. The signal pathway (22) can comprises either a direct wired connection or a radio frequency reader (40) on the printer (30) may be used to interrogate the radio frequency device (12) via a wireless connection (42).

### TECHNICAL FIELD

The present invention relates to systems and methods of storing and retrieving printer configuration settings and to the utilization of a radio frequency device to store printer configuration data that may be accessed by host enabling a printer to assume a desired default configuration.

### BACKGROUND OF THE INVENTION

Printers have become commonplace equipment in most workplace and home computing environments. Today, many printers are sophisticated multi-function electronic assemblies with internal memory devices and embedded software algorithms that allow the configuration of printer settings based on the needs of the end user and/or the contemplated use of the individual printer. By storing printer settings in a printer's internal memory a single printer may be custom configured to accommodate differing use requirements such as, for example, default language and paper size settings.

Examples of other print configuration settings which may be stored in a printer's internal memory include destination country, date code, toner cartridge type, power saver timeout, model and/or serial number, distributor or dealer identity, firmware version, date of manufacture, toner cartridge ID, and other system related data.

Typically, and to accommodate modern manufacturing, product inventory and customer order mechanisms, the task of setting default print configuration settings that control startup printer functions is done near the end of the manufacturing cycle after the product has been packaged and made ready for shipment. Oftentimes, it is necessary to unpack the printer assembly, power-up the printer, set or reset default configuration settings and re-pack the assembly prior to shipment. Such practices lead to inefficiencies, unnecessary expense and overall lack of flexibility in the product distribution process.

As such, there is a need for a more efficient and flexible means of setting printer configuration settings to accommodate differing customer requirements. A method of setting print configuration data within the printer assembly that eliminates the need to unpack, power-up, set or reset settings, and re-pack a printer prior to shipment would provide numerous advantages.

### BRIEF DESCRIPTIONS OF THE DRAWINGS

The present invention is illustrated by way of example and not limitation in the figures of the accompanying drawings in which like references indicate similar elements, and in which:

FIG. 1 is a block diagram of a printer configuration system according to one embodiment of the invention;

FIG. 2 is a block diagram of a printer configuration system according to a second embodiment of the invention;

FIG. 3 is a process flow diagram for a method of customizing a printer to achieve a desired printer configuration according to the invention; and

FIG. 4 is a process flow diagram for a method of configuring a multi-functional electronic assembly according to the invention.

References in the detailed description refer to like references in the figures unless otherwise indicated.

### DETAILED DESCRIPTION

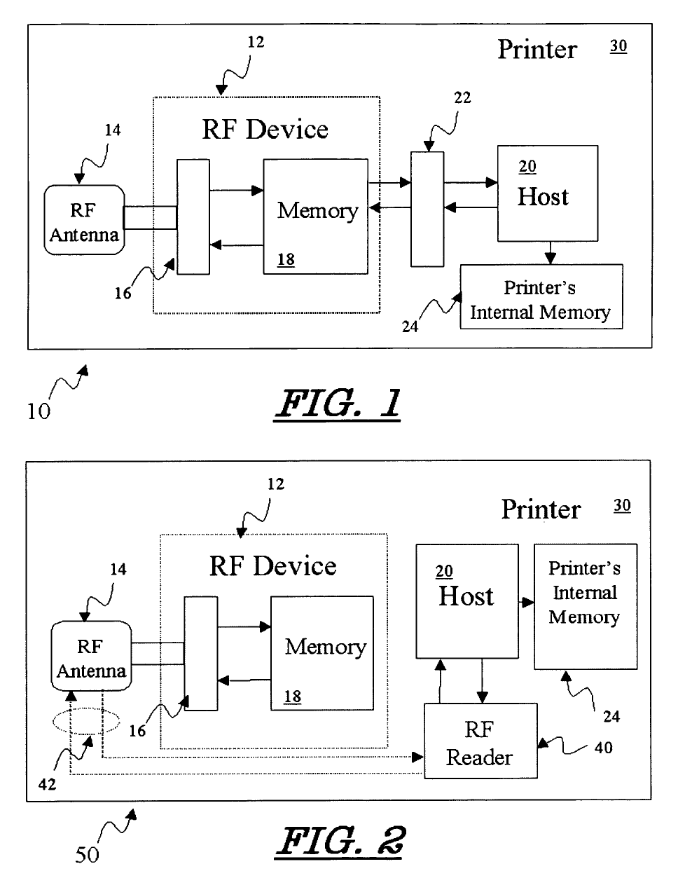

With reference to FIGS. 1 and 2, two embodiments of a printer configuration system according to the invention are illustrated. In FIG. 1, a printer configuration system 10 includes a radio frequency device 12 which may be any component that responds RF signals. In one embodiment, radio frequency device 12 may be any one of a plurality of commercially available RFID tags which are small integrated circuits connected to an antenna and which can respond to an interrogating RF signal with identifying information. Accordingly, radio frequency device 12 is shown connected to an Radio Frequency (RF) antenna 14 which allows the radio frequency device 12 to be interrogated by an external radio frequency reader (not shown) to provide a complete radio frequency system.

Radio frequency device 12 includes an air interface 16 which provides a signal pathway for communicating with the radio frequency device 12 via the RF antenna 14. Radio frequency device 12 includes memory 18 in which data may be stored. As such, an external RF reader (not shown) may be used to store a plurality of information specific to a multi-function electronic assembly, such as printer 30, in order to make such information available for later use. In this way, the invention provides a way for configuring a multi-function electronic assembly without the expense and inefficiencies associated with unpacking, powering-up the assembly, manually setting the information within the assemblies' internal memory and re-packing the assembly prior to shipment.

The invention may use a radio frequency device 12 in order to store printer configuration settings data within a memory space, such as memory 18 of radio frequency device 12, to allow a printer to assume a desired state of functionality. Examples of the kind of printer configuration settings data that may be stored within memory 18 include destination country, date code, toner cartridge type, power saver timeout, model and/or serial number, distributor or dealer identity, firmware version, date of manufacture, toner cartridge ID, as well as other printer related data.

The data stored in memory 18 of radio frequency device 12 may be written to radio frequency device 12 at any point during the printer's manufacturing and/or product distribution cycle. For example, the order details for a specific printer model may be embedded in the radio frequency device 12 prior to readying the printer for shipment. The details can include the specific distribution channel, destination country, default paper size and a plurality of other particulars relevant to the intended use of the printer. If, for example, the order is changed prior to shipment, the order details may be re-written into the radio frequency device 12 at the manufacturing facility without unpacking the printer to reset its default settings. Likewise, should the printer be returned by the distributor, retailer or end-customer, the order details may be re-recorded in the radio frequency device 12 using an appropriate RF reader. The fact that radio frequency device 12 allows printer configuration settings information to be stored and altered eliminates the costs and inefficiencies associated with unpacking, powering-up and re-packing a printer.

FIG. 1 also shows that host 20, radio frequency device 12 and RF antenna 14 may be affixed directly to the printer 30. Alternatively, radio frequency device 12 may be attached to the packaging, i.e. box, shipping label, crate, etc. . . . in which printer 30 is shipped, with host 20 predisposed to access the radio frequency device 12. Other configurations of a suitable RF component, such as radio frequency device 12, that enable it to be interrogated by an external RF reader (not shown) and accessed by a subsystem of the printer assembly, such as host 20, to access the contents in memory 18 may be utilized.

The host 20 can comprise any suitable arrangement of process logic and/or hardware that allow printer 30 to access contents of memory 18. As such host 20 may comprise a host processor. For example, instructions stored in the printer's internal memory subsystem may cause host 20 to query memory 18, obtain data stored therein and download the stored data to the printer's internal memory 24. In this way, printer 30 associated with host 20 may be configured for desired print related functions. As shown, host 20 accesses memory 18 of radio frequency device 12 through signal pathway 22 which provides a direct wired interface to radio frequency device 12. In contrast, with printer configuration system 50 shown in FIG. 2, the printer 30 is equipped with a RF reader 40 to interrogate radio frequency device 12 without requiring a direct wired connection. In addition, using this embodiment the RF reader 40 may be used for other purposes such as, for example, to write printer status information in memory 18 of radio frequency device 12. Thus, signal pathway 42 may provide an air interface to the radio frequency device 12.

Radio frequency device 12 may comprise any one of a plurality of readily available commercial RFID components having sufficient memory for storing a plurality of printer configuration settings data. An example of such a component would include the ATMEL® Asset Identification EEPROM AT24RF08C dual access EEPROM with dual-port non-volatile memory and RFID and serial interfaces. It is contemplated that other similar or suitable RF components are or will be available.

As such, according to one exemplary embodiment, the present invention provides a printer configuration system 10 with a radio frequency device 12 with memory 18 for storing a plurality of printer device parameter data and a signal pathway 22 for communicating with the RF device 12. The system further comprises a host 20 capable of accessing the radio frequency device 12 through the signal pathway 22 for obtaining the printer device parameter data stored in the radio frequency device 12 which is read by the host 20 via the signal pathway 22 and used by a printer 30 associated with the host 20 to configure printer related functions. The signal pathway 22 may comprise either a direct wired connection or, alternatively, an RF reader 40 on the printer 30 may be used to interrogate the radio frequency device 12 via a wireless connection 42.

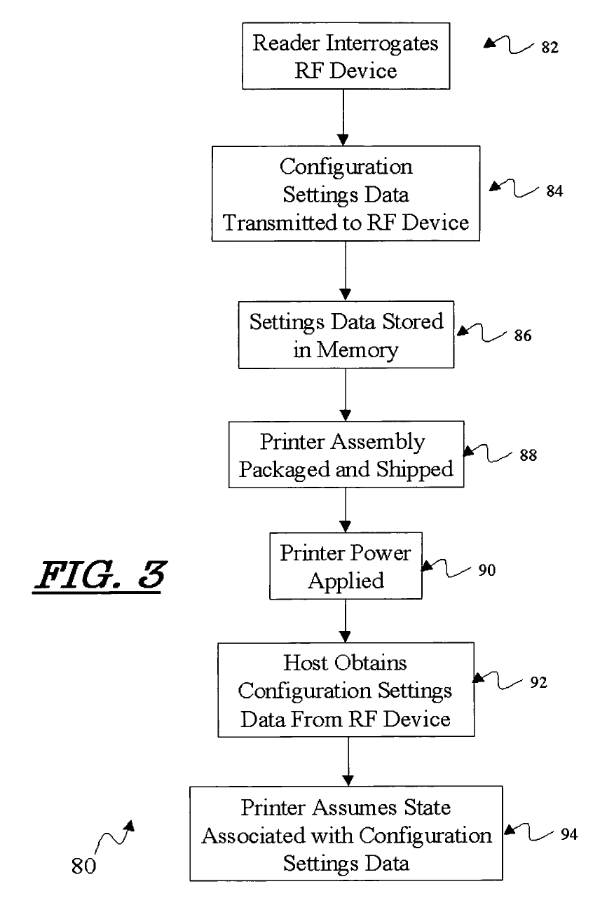

With reference to FIG. 3, a process flow diagram for a method of customizing a printer to achieve a desired printer configuration is shown and denoted generally as 80. Process flow starts at step 82 wherein an external RF reader interrogates a radio frequency device, such as radio frequency device 12, predisposed about a multi-function electronic assembly, such as printer 30, in order to write data to the radio frequency device. Next, at step 84, configuration settings data is transmitted to the RF device and stored in memory associated with the radio frequency device, step 86. At this point, the multi-function electronic assembly is made ready for shipment by packaging in an appropriate shipment container prior to shipment to its intended destination, i.e., distributor, retailer or end-customer, step 88. Once received and unpacked, power may be applied to the multi-function electronic assembly, step 90, and a host within the printer, such as host 20, can obtain the configuration settings data stored in the radio frequency device, step 92. Step 92 may be achieved by communicating via a direct wired connection between the host and the radio frequency device or, alternatively, using an RF reader, such as RF reader 40, providing a wireless interface to the radio frequency device. Finally, at step 94, the printer assumes a state of functionality associated with the configuration settings data stored in the radio frequency device. For example, the configurations settings data may dictate that a printer shipped to a Spanish speaking country power-up with Spanish as the default language. If so, data written in the radio frequency device could be obtained by a host associated with the multi-function electronic assembly causing the assembly to power-up in Spanish as the default language. Of course, a plurality of other printer configuration functions may be determined by the systems and methods of this invention.

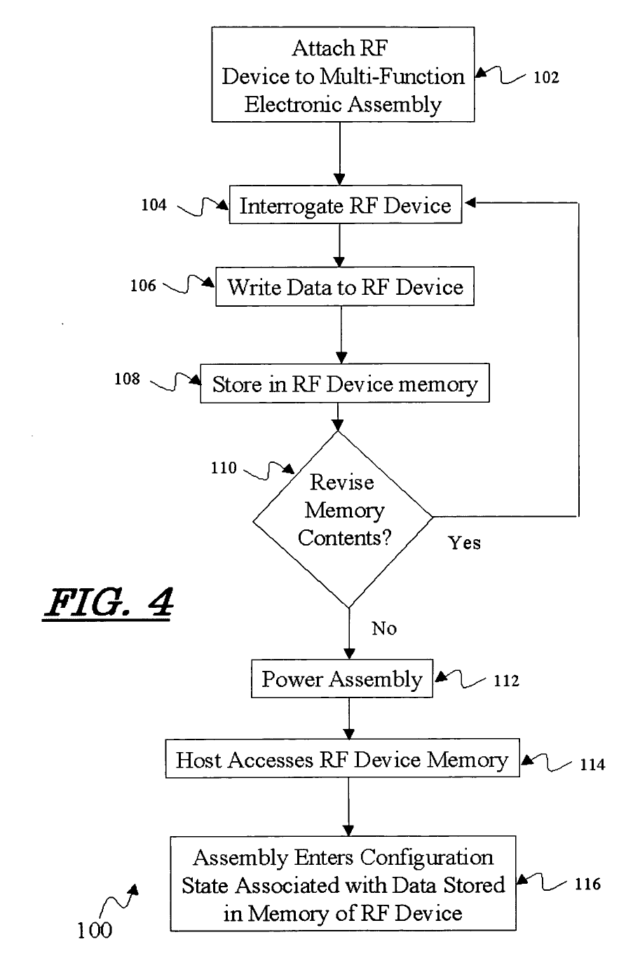

With reference to FIG. 4, a process flow diagram for a method of configuring a multi-functional electronic assembly, such as a printer, using a radio frequency device such as, for example, a commercially available Radio Frequency Identification (RFID) tag is shown and denoted generally as 100. At step 102, a radio frequency device is attached to a multi-function assembly, such as printer 30. Step 30 involves attaching the radio frequency device directly to the assembly or, alternatively, to the shipping container in which the assembly is shipped. Next, at step 104, the radio frequency device is interrogated by, for example, an external RF reader used to communicate with the radio frequency device using an RF antenna. Data, such as printer configuration settings data, is written to the radio frequency device, step 106, and stored in the device's memory, step 108.

The use of a RF device permits the information stored in the device's memory to be written and re-written at any point in the product manufacturing and/or distribution process. Likewise, if the multi-function electronic assembly is equipped with an onboard RF reader, the assembly can write data to the device. At step 110, a decision is made if the information in the device's memory should be revised and/or updated. If so, process flow is directed to step 104 wherein the RF device is interrogated and data written to the device, step 106. Once all desired data is stored in the device's memory, process flow is directed to step 112 wherein power is applied to the assembly following, for example, shipment to an end user. Next, at step 114, a host subsystem within the assembly accesses the RF device's memory to obtain the data stored therein. Finally, at step 116, the assembly enters a configuration state associated with the data obtained from the RF device's memory. In this way, the assembly may be configured using a suitable radio frequency device, such as a commercially available RF device with sufficient memory.

It should be understood that modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A printer configuration system comprising:
a radio frequency device with memory for storing a plurality of printer device parameter data;
a first signal pathway for communicating with said radio frequency device; and
a host capable of accessing said radio frequency device through said first signal pathway;
wherein printer device parameter data stored in said radio frequency device may be read by said host via said first signal pathway and used by a printer associated with said host to configure printer related functions.

2. The printer configuration system of claim 1 further comprising a second signal pathway and wherein said first signal pathway comprises a first interface for writing printer device parameter data to said memory and said second signal pathway comprises a second interface for reading printer device parameter data from said memory.

3. The printer configuration system of claim 2 wherein said first interface comprises an air interface having an antenna through which a radio frequency reader writes data to said memory.

4. The printer configuration system of claim 3 wherein said second interface comprises a wired connection coupling said host to radio frequency device.

5. The printer configuration system of claim 1 wherein said first signal pathway comprises an air interface having an antenna through which a radio frequency reader may write data to and read data from said memory.

6. The printer configuration system of claim 5 further wherein said host includes a radio frequency reader for accessing data stored in said memory via said air interface.

7. The printer configuration system of claim 1 wherein parameter data comprises data indicative of the destination country to which said printer will be shipped.

8. The printer configuration system of claim 1 wherein parameter data comprises data indicative of the language option associated with the destination country to which said printer will be shipped.

9. The printer configuration system of claim 1 wherein said radio frequency device comprises a RFID tag.

10. A system for maintaining printer configuration settings comprising:
a radio frequency device with memory for storing a plurality of printer configuration settings data, and an air interface;
an radio frequency antenna for interrogating said radio frequency device via said air interface; and
a printer equipped with a host processor and communicably coupled to said radio frequency device for accessing said memory and retrieving printer configuration settings data stored in said memory;
wherein data written to said memory of said radio frequency device allows the storage of printer configuration settings data, said printer configuration settings data accessible by said host processor of said printer allowing a desired configuration of said printer.

11. The system of claim 10 wherein said host processor comprises an radio frequency reader for interrogating said radio frequency device via said air interface.

12. The system of claim 10 further comprising a second interface to said radio frequency device and wherein said host processor accesses said radio frequency device via said second interface.

13. The system of claim 12 wherein said second interface is a wired connection.

14. The system of claim 10 wherein printer configuration settings are written in said memory of said radio frequency device after said printer is packaged for shipping.

15. The system of claim 10 wherein said printer configuration settings data comprises data indicative of the destination country to which said printer will be shipped.

16. The system of claim 10 wherein said printer configuration settings data comprises data indicative of the language option associated with the destination country to which said printer will be shipped.

17. The system of claim 10 wherein said printer further comprises non-volatile memory space and wherein printer configuration settings data retrieved from said memory of said radio frequency device is stored in said non-volatile memory.

18. A method of customizing a printer to achieve a desired printer configuration comprising the steps of:
writing printer configuration settings data to a radio frequency device associated with a printer;
a host within the printer obtaining the printer configuration settings data by accessing the radio frequency device; and
the printer automatically assuming a state of functionality associated with the printer configuration settings data.

19. The method of claim 18 wherein said radio frequency device comprises a RFID tag that is read-writeable and attached to said printer and wherein said writing step is performed after said printer is packaged for shipping.

20. The method of claim 20 wherein said writing step is performed by an external RFID reader interrogating said RFID tag.

21. The method of claim 18 wherein said host within said printer includes a radio frequency reader and further comprising the step of said radio frequency reader interrogating said radio frequency device to obtain said printer configuration settings data.

22. Using a radio frequency device, a method of configuring a multi-functional electronic assembly comprising the steps of:
placing a radio frequency device within proximity of the electronic assembly;
a first radio frequency reader interrogating the radio frequency device and writing a plurality of configuration data to a memory space associated with the radio frequency device;
the electronic assembly assuming a power-on state;
a host within the electronic assembly accessing the memory to obtain the configuration data; and
the electronic assembly assuming a state of functionality associated with the configuration data.

23. The method of claim 22 wherein said placing step is performed by attaching the radio frequency device directly to the electronic assembly.

24. The method of claim 22 wherein said host accesses said memory via a wired connection to said radio frequency device.

25. The method of claim 22 wherein said host accesses said memory via a second radio frequency reader within said electronic assembly.

26. The method of claim 22 wherein said plurality of configuration data comprises data indicative of the destination country.

27. The system of claim 22 wherein said plurality of configuration data comprises data indicative of the language option associated with the destination country to which said electronic assembly will be shipped.
